(19) United States
(12) Patent Application Publication
(10) Pub. No.: US 2018/0020071 A1
(43) Pub. Date: Jan. 18, 2018

(54) METHOD, SYSTEM AND NON-TEMPORARY COMPUTER-READABLE RECORDING MEDIUM FOR PROVIDING SCHEDULE-RELATED NOTIFICATION

(71) Applicant: Konolabs, Inc., Seoul (KR)

(72) Inventors: Joon Hee Kim, Seongnam-si (KR); Jung Hee Ryu, Seoul (KR)

(73) Assignee: Konolabs, Inc., Seoul (KR)

(21) Appl. No.: 15/718,792

(22) Filed: Sep. 28, 2017

Related U.S. Application Data
(63) Continuation of application No. PCT/KR2016/009539, filed on Aug. 26, 2016.

(30) Foreign Application Priority Data
Aug. 28, 2015 (KR) 10-2015-0122104

(51) Int. Cl. H04L 29/08; G06Q 10/10

(52) U.S. Cl. CPC H04L 67/26; G06Q 10/1093

(57) ABSTRACT

A method for providing a schedule-related notification, according to an embodiment of the present invention, is provided. The method includes the steps of: collecting information about the attribute of a notification provided for a user and/or information about a situation in which the notification is provided and collecting information about the user's response to the notification; and, in reference to the collected information., adaptively controlling at least a part of the attribute of the notification provided for the user.

### CROSS-REFERENCE TO RELATED APPLICATIONS

This application is a continuation application of Patent Cooperation. Treaty (PCT) international application Serial No. PCT/KR2016/009539, filed on Aug. 26, 2016, which claims priority to Korean Patent Application Serial No. 10-2015-0122104, filed on Aug. 28, 2015. The entire W contents of PCT international application Serial No. PCT/KR2016/009539, and Korean Patent Application Serial No. 10-2015-0122104 are hereby incorporated by reference.

### FIELD OF THE INVENTION

The present invention relates to a method, system, and non-transitory computer-readable recording medium for providing a notification of schedule.

### BACKGROUND

In order to create a new event in a conventional calendar program (or application), a user should personally find an empty time slot in a time table, and manually enter specific information on the event one by one, such as a to-do item, location, start time, end time, recurrence, and notification time before the event. Therefore, a problem occurs in that the user should take much time and effort to manage schedule. Although a variety of calendar programs are developed recently, those calendar programs simply differ in terms of exterior elements such as designs or titles, and basically have the same problem as above.

Further, a conventional calendar program may only provide schedule management functionality for a single user, and thus, when managing an event in which two or more users are involved, the users cannot avoid the inconvenience of personally contacting each other separately from the calendar program to discuss about the time or location of the event, and entering information on the determined time or location of the event into the calendar program, one by one.

Meanwhile, in order to address the above problem of conventional calendar programs, there have been introduced programs for supporting convenient management of to-do lists. Such a to-do list management program may function to allow a user to conveniently enter and list his/her to-do items and to check the completion of the to-do items, but cannot give consideration to the duration of each to-do item or other events included in the user's schedule. Thus, the program has a limitation in that it is difficult to generally manage the user's schedule using the program.

Further, the conventional calendar programs usually provide a notification (i.e., reminder) of an event at a specific time determined by a user in the form of a push notification, e-mail, or the like. Since such a notification is provided in a fixed form according to the attributes determined automatically or by the user, the user is accustomed to the notification provided in the same pattern every time, or treats the notification as a spam. Accordingly, such a notification may frequently fail to function properly (e.g., to communicate information, to elicit the user's action, or the like).

In this connection, the inventor(s) present a technique for adaptively controlling the attributes of a notification provided to a user, with reference to a response that the user makes in response to the notification.

### SUMMARY OF THE INVENTION

One object of the present invention is to solve all the above problems in prior art.

Another object of the invention is to provide a notification that may elicit a proper response from a user, by collecting information on attributes of a notification provided to a user or information on a situation in which the notification is provided, and collecting information on a response that the user makes in response to the notification; and adaptively controlling at least a part of the attributes of the notification provided to the user, with reference to the collected information.

The representative configurations of the invention to achieve the above objects are described below.

According to one aspect of the invention, there is provided a method for providing a notification of schedule, comprising the steps of: collecting at least one of information on attributes of a notification provided to a user and information on a situation in which the notification is provided, and collecting information on a response that the user makes in response to the notification; and adaptively controlling at least a part of the attributes of the notification provided to the user, with reference to the collected information.

According to another aspect of the invention, there is provided a system for providing a notification of schedule, comprising: an information collection unit configured to collect at least one of information on attributes of a notification provided to a user and information on a situation in which the notification is provided, and to collect information on a response that the user makes in response to the notification; and a notification control unit configured to adaptively control at least a part of the attributes of the notification provided to the user, with reference to the collected information.

In addition, there are further provided other methods and systems to implement the invention, as well as non-transitory computer-readable recording media having stored thereon computer programs for executing the methods.

According to the invention, it is possible to provide a notification that may elicit a proper response from a user, by adaptively controlling the attributes of the notification according to the user's response to the notification, so that the notification may far better function to communicate information and elicit the user's action.

### BRIEF DESCRIPTION OF THE DRAWINGS

FIG. 1 schematically shows the configuration of an entire system for providing a notification of schedule according to one embodiment of the invention.

FIG. 2 illustratively shows the internal configuration of a service provision system according to one embodiment of the invention.

FIGS. 3A and 3B illustratively show how a notification of schedule is provided according to one embodiment of the invention.

### DETAILED DESCRIPTION

In the following detailed description of the present invention, references are made to the accompanying drawings that show, by way of illustration, specific embodiments in which the invention may be practiced. These embodiments are described in sufficient detail to enable those skilled in the art to practice the invention. It is to be understood that the various embodiments of the invention, although different from each other, are not necessarily mutually exclusive. For example, specific shapes, structures and characteristics described herein may be implemented as modified from one embodiment to another without departing from the spirit and scope of the invention. Furthermore, it shall be understood that the positions or arrangements of individual elements within each of the disclosed embodiments may also be modified without departing from the spirit and scope of the invention. Therefore, the following detailed description is not to be taken in a limiting sense, and the scope of the invention, if properly described, is limited only by the appended claims together with all equivalents thereof. In the drawings, like reference numerals refer to the same or similar functions throughout the several views. Hereinafter, preferred embodiments of: the present invention will be described in detail with reference to the accompanying drawings to enable those skilled in the art to easily implement the invention.

Configuration of an Entire System

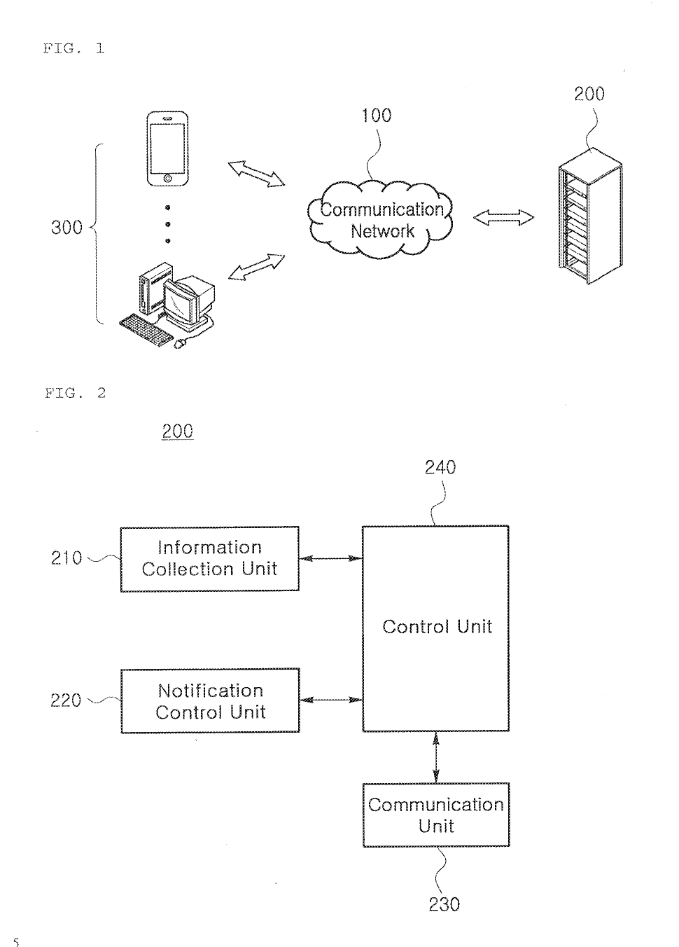

FIG. 1 schematically shows configuration of an entire system for providing a notification of schedule according to one embodiment of the invention.

As shown in FIG. 1, the entire system according to one embodiment of the invention may comprise a communication network 100, a service provision system 200, and a user terminal device 300.

First, the communication network 100 according to one embodiment of the invention may be implemented regardless of communication modality such as wired and wireless communications, and may be constructed from a variety of communication networks such as local area networks (LANs), metropolitan area networks (MANs), and wide area networks (WANs). Preferably, the communication network 100 described herein may be the Internet or the World Wide Web (WWW). However, the communication network 100 is not necessarily limited thereto, and may at least partially include known wired/wireless data communication networks, known telephone networks, or known wired/wireless television networks.

Next, the service provision system 200 according to one embodiment of the invention may function to provide a notification that may elicit a proper response from a user, by collecting information on attributes of a notification provided to a user or information on a situation in which the notification is provided, and collecting information on a response that the user makes in response to the notification; and adaptively controlling at least a part of the attributes of the notification provided to the user, with reference to the collected information.

The configuration and function of the service provision system 200 according to the invention will be discussed in detail in the following description.

Next, according to one embodiment of the invention, the user terminal device 300 is digital equipment capable of allowing a user to connect to and then communicate with the service provision system 200, and any type of digital equipment having a microprocessor and a memory means for computing capabilities, such as smart phones, tablets, desktop computers, notebook computers, workstations personal digital assistants (PDAs), web pads, and mobile phones, may be adopted as the user terminal device 300 according to the invention.

Particularly, the user terminal device 300 may include an application (not shown) to assist a user to receive services from the service provision system 200. The application may be downloaded from the service provision system 200 or a known web server (not shown). It is apparent that the application may be provided by implementing a calendar GUI of a conventional calendar program (e.g., calendar GUI for schedule management in Microsoft Outlook) as necessary. At least a part of information for constructing the calendar GUI may be received from the service provision system 200.

Configuration of the Service Provision System

Hereinafter, the internal configuration of the service provision system 200 crucial for implementing the invention and the functions of the respective components thereof will be discussed.

FIG. 2 illustratively shows the internal configuration of the service provision system according to one embodiment of the invention.

Referring to FIG. 2, the service provision system 200 according to one embodiment of the invention may comprise an information collection unit 210, a notification control unit 220, a communication unit 230, and a control unit 240. According to one embodiment of the invention, at least some of the information collection unit 210, the notification control unit 220, the communication unit 230, and the control unit 240 may be program modules to communicate with an external system (not shown). The program modules may be included in the service provision system 200 in the form of operating systems, application program modules, and other program modules, while they may be physically stored in a variety of commonly known storage devices. Further, the program modules may also be stored in a remote storage device that may communicate with the service provision system 200. Meanwhile, such program modules may include, but not limited to, routines, subroutines, programs, objects, components, data structures, and the like for performing specific tasks or executing specific abstract data types as will be described below in accordance with the invention.

First, according to one embodiment of the invention, the information collection unit 210 may function to collect information on attributes of a notification provided to a user or information on a situation in which the notification is provided.

Here, according to one embodiment of the invention, the information on the attributes of the notification may include information on a type of the notification, an aural, visual, or tactile signal constituting the notification, a nuance of a message contained in the notification, and a time or frequency at which the notification is provided. For example, the information collection unit 210 according to one embodiment of the invention may collect information indicating that the notification is provided at 7:30 am every day, or information indicating that the notification is provided in an e-mail format.

According to one embodiment of the invention, the information on the situation in which the notification is provided may include information on a remaining time before a start time of an event related to the notification, a distance at which the user is away from a location of the event related to the notification, and whether the user is implementing another event. For example, the information collection unit 210 according to one embodiment of the invention may collect information indicating that the notification was provided 30 minutes before a start time of an event related to the notification, or information indicating that the user was about 3 km away from a location of the event related to the notification when notification was provided.

Further, according to one embodiment of the invention, the information collection unit 210 may function to collect information on a response that the user makes in response to the notification provided as above.

Here, according to one embodiment of the invention, the information on the user's response may include information on whether the user checks the notification, a time that the user takes to check the notification, a history of the user's implementation of an event related to the notification, and a relocation of the user after the notification is provided to the user. For example, the information collection unit 210 according to one embodiment of the invention may collect information indicating that the user made a response by performing a swipe operation in two seconds after receiving the notification to dismiss the notification, or information indicating that the user made a response by ignoring the notification without performing any operation even after receiving the notification.

However, it is noted that the information that may be collected by the information collection unit 210 according to the invention is not necessarily limited to the foregoing, and may be changed without limitation as long as the objects of the invention may be achieved.

Next, according to one embodiment of the invention, the notification control unit 220 may function to adaptively control at least a part of the attributes of the notification provided to the user, with reference to the information collected as above.

Specifically, according to one embodiment of the invention, the notification control unit 220 may use a learning algorithm to generate a model of a relationship between the attributes of the notification or the situation in which the notification is provided and the user's response to the notification, and may control at least a part of the attributes of the notification provided to the user, with reference to the model generated as above, such that a desired response may be elicited from the user.

A variety of learning algorithms may be used in the invention to generate a model of a relationship between the attributes of the notification or the situation in which the notification is provided and the user's response, and one example thereof may be a reinforcement learning algorithm. Hereinafter, embodiments for generating the model using a reinforcement learning algorithm and adaptively controlling the attributes of a notification will be described in more detail.

First, the notification control unit 220 according to one embodiment of the invention may generate, for each notification provided to a user, a data set composed of data on a situation in which the notification is provided, data on the attributes of the notification, and data on the user's response. Here, the data on the user's response may be quantified according to how proper a response is made by the user. For example, a value of 20 may be given when the user attends an event on time (i.e., when a proper response is made), and a value of −5 may be given when the user is five minutes late for an event (i.e., when a proper response is not made).

Next, the notification control unit 220 according to one embodiment of the invention may generate a model of a relationship between the attributes of the notification or the situation in which the notification is provided and the user's response to the notification, by applying a reinforcement learning algorithm to at least one data set generated as above, and may control the attributes of the notification, with reference to the model generated as above, such that a proper response may be elicited from the user.

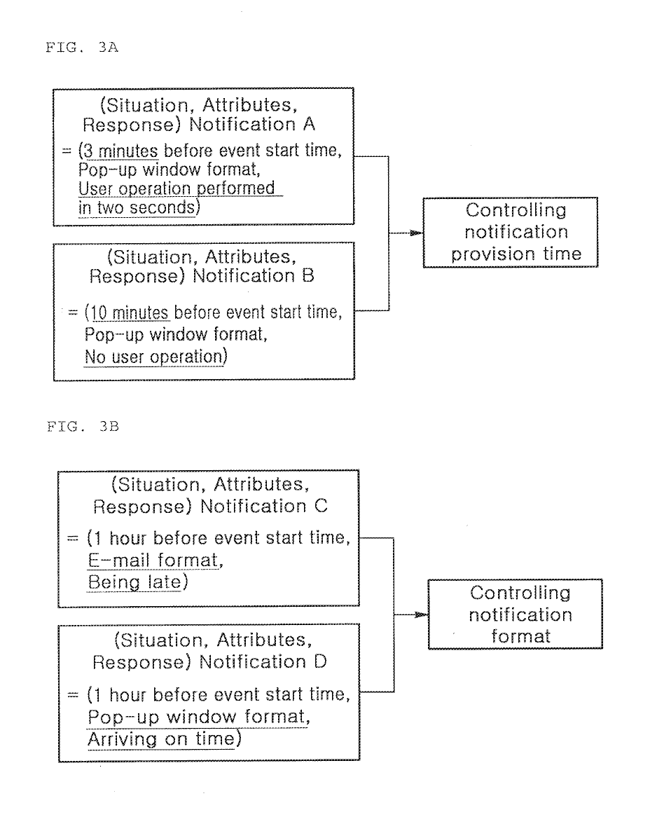

For example, if a user makes a quicker response to a notification provided three minutes before a start time of an event than to a notification provided ten minutes before the start time of the event, the notification control unit 220 according to one embodiment of the invention may control a time at which a notification is provided to the user such that the time is closer to a start time of an event related to the notification (see FIG. 3A).

As another example, if a user is less likely to be late for an event when a notification in a pop-up window format is provided in relation to the event than when a notification in an e-mail format is provided, the notification control unit 220 according to one embodiment of the invention may control a notification provided to the user such that the notification is composed in a pop-up window format (see FIG. 3B).

As yet another example, if a user is more likely to attend an event when a notification containing an imperative message is provided in relation to the event than when a notification containing a solicited message is provided, the notification control unit 220 according to one embodiment of the invention may control a notification provided to the user such that a message contained in the notification is composed in an imperative manner.

Although the embodiments using a reinforcement learning algorithm have been mainly described above, it is noted that the present invention is not necessarily limited to the above embodiments, and any other learning algorithm may be used to control the attributes of a notification as long as the objects of the invention may be achieved.

Meanwhile, the communication unit 230 according to one embodiment of the invention may function enable the service provision system 200 to communicate with an external device such as the user terminal device 300.

Lastly, the control unit 240 according to one embodiment of the invention may function to control data flow among the information collection unit 210, the notification control unit 220, and the communication unit 230. That is, the control unit 240 may control inbound data flow or data flow among the respective components of the service provision system 200, such that the information collection unit 210, the notification control unit 220, and the communication unit 230 may carry out their particular functions, respectively.

The embodiments according to the invention as described above may be implemented in the form of program instructions that can be executed by various computer components, and may be stored on a non-transitory computer-readable recording medium. The non-transitory computer-readable recording medium may include program instructions, data files, data structures and the like, separately or in combination. The program instructions stored on the non-transitory computer-readable recording medium may be specially designed and configured for the present invention, or may also be known and available to those skilled in the computer software field. Examples of the non-transitory computer-readable recording medium include the following: magnetic media such as hard disks, floppy disks and magnetic tapes; optical media such as compact disk-read only memory (CD-ROM) and digital versatile disks (DVDs)); magneto-optical media such as floptical disks; and hardware devices such as read-only memory (ROM), random access memory (RAM) and flash memory, which are specially configured to store and execute program instructions. Examples of the program instructions include not only machine language codes created by compiler or the like, but also high-level language codes that can be executed by a computer using an interpreter or the like. The above hardware devices may be configured to operate as one or more software modules to perform the processes of the present invention, and vice versa.

Although the present invention has been described above in terms of specific items such as detailed elements as well as the limited embodiments and the drawings, they are only provided to help more general understanding of the invention, and the present invention is not limited to the above embodiments. It will be appreciated by those skilled in the art to which the present invention pertains that various modifications and changes may be made from the above description.

Therefore, the spirit of the present invention shall not be limited to the above-described embodiments, and the entire scope of the appended claims and their equivalents will fall within the scope and spirit of the invention.

What is claimed is:

1. A method for providing a notification of schedule, comprising the steps of:
collecting at least one of information on attributes of a notification provided to a user and information on a situation in which the notification is provided, and collecting information on a response that the user makes in response to the notification; and
adaptively controlling at least a part of the attributes of the notification provided to the user, with reference to the collected information.

2. The method of claim 1, wherein the information on the attributes of the notification includes information on at least one of a type of the notification, an aural, visual, or tactile signal constituting the notification, a nuance of a message contained in the notification, and a time or frequency at which the notification is provided.

3. The method of claim 1, wherein the information on the situation in which the notification is provided includes information on at least one of a remaining time before a start time of an event related to the notification, a distance at which the user is away from a location of the event related to the notification, and whether the user is implementing another event.

4. The method of claim 1, wherein the information on the user's response includes information on at least one of whether the user checks the notification, a time that the user takes to check the notification, a history of the user's implementation of an event to the notification, and a relocation of the user after the notification is provided.

5. The method of claim 1, wherein the controlling step comprises:
generating a model of a relationship between attributes of the notification or the situation in which the notification is provided and the user's response, using a learning algorithm; and
adaptively controlling at least a part of the attributes of the notification provided to the user, with reference to the generated model.

6. A non-transitory computer-readable recording medium having stored thereon a computer program for executing the method of claim 1.

7. A system for providing a notification of schedule, comprising:
an information collection unit configured to collect at least one of information on attributes of a notification provided to a user and information on a situation in which the notification is provided, and to collect information on a response that the user makes in response to the notification; and
a notification control unit configured to adaptively control at least a part of the attributes of the notification provided to the user, with reference to the collected information.

8. The system of claim 7, wherein the information on the attributes of the notification includes information on at least one of a type of the notification, an aural, visual, or tactile signal constituting the notification, a nuance of a message contained in the notification, and a time or frequency at which the notification is provided.

9. The system of claim 7, wherein the information on the situation in which the notification is provided includes information on at least one of a remaining time before a start time of an event related to the notification, distance at which the user is away from a location of the event related to the notification, and whether the user is implementing another event.

10. The system of claim 7, wherein the information on the user's response includes information on at least one of whether the user checks the notification, a time that the user takes to check the notification, a history of the user's implementation of an event related to the notification, and a relocation of the user after the notification is provided.

11. The system of claim 7, wherein the notification control unit is configured to generate a model of a relationship between the attributes of the notification or the situation in which the notification is provided and the user's response, using a learning algorithm, and to adaptively control at least a part of the attributes of the notification provided to the user, with reference to the generated model.
